(19) United States
(12) Patent Application Publication
(10) Pub. No.: US 2014/0103909 A1
(43) Pub. Date: Apr. 17, 2014

(54) METHOD AND APPARATUS FOR DETECTING POSITION AND STARTUP A SENSORLESS MOTOR

(71) Applicants: Yi-Chi Lin, Taichung City (TW); Yung-Sheng Wu, New Taipei City (TW)

(72) Inventors: Yi-Chi Lin, Taichung City (TW); Yung-Sheng Wu, New Taipei City (TW)

(73) Assignee: SYSTEM GENERAL CORP., New Taipei City (TW)

(21) Appl. No.: 14/048,037

(22) Filed: Oct. 8, 2013

Related U.S. Application Data
(60) Provisional application No. 61/714,905, filed on Oct. 17, 2012.

(51) Int. Cl. G01B 7/00

(52) U.S. Cl. CPC G01B 7/00
USPC 324/176

(57) ABSTRACT

A method and a circuit for detecting positions for a motor are provided. The circuit includes a control circuit for generating PWM signals, high-side transistors and low-side transistors, resistors and a microcontroller. The high-side transistors and the low-side transistors generate voltage signals configured to drive the motor. The resistors coupled to the low-side transistors generate sensing signals in response to motor currents and back-EMF signals. The microcontroller controls the control circuit. the PWM signals are utilized to control the high-side transistors and the low-side transistor for generating the voltage signals. The high-side transistors are coupled to the input power source. The low-side transistors are coupled to the ground via the resistors. The control circuit determines the motor position in accordance with the sensing signals.

### CROSS-REFERENCE TO RELATED APPLICATION

This application claims the priority benefits of U.S. provisional application Ser. No. 61/714,905, filed on Oct. 17, 2012. The entirety of the above-mentioned patent applications is hereby incorporated by reference herein and made a part of this specification.

### BACKGROUND OF THE INVENTION

1. Field of the Invention

The present invention relates to a permanent magnet (PM) motor control technology, and particularly relates to a method and an apparatus for detecting the motor position of sensor-less permanent magnet motors, (e.g., brushless permanent magnet synchronous motors (PMSM)).

2. Background of the Invention

A brushless permanent magnet synchronous motor (PMSM) is one kind of sensor-less PM motors, and is an electric motor driven by an AC electrical input. If the startup position of sensor-less permanent magnet motors can be detected, the motor can be started up without jerk.

The PMSM comprises a wound stator, a permanent magnet rotor assembly and a device to sense the rotor position. The sensing device provides the signals (motor position) for electronically switching the stator windings in the proper sequence to maintain the rotation of the magnet assembly. Conventionally, the sensing devices are hall-sensors. However, the hall-sensors increase cost and reliability problem of motors. Therefore, the sensor-less control became a major requirement for the PM motor control in the market.

### SUMMARY OF THE INVENTION

The present invention provides a circuit for detecting positions of a motor. The circuit comprises a control circuit for generating PWM signals, high-side transistors and low-side transistors, resistors and a microcontroller. The high-side transistors and the low-side transistors generate voltage signals configured to drive the motor. The resistors coupled to the low-side transistors generate sensing signals in response to motor currents and back-EMF signals. The microcontroller is configured to take control of the control circuit. The PWM signals are configured to control the high-side transistors and the low-side transistors for generating the voltage signals. The high-side transistors are coupled to an input power source. The low-side transistors are coupled to the ground via the resistors. The control circuit is configured to determine a motor position in accordance with the sensing signals.

From another point of view, the present invention further provides a method for detecting positions of a motor. The method comprises the following steps: generating PWM signals; generating voltage signals configured to drive the motor by switching high-side transistors and, low-side transistors; generating sensing signals flowing through resistors in response to back-EMF signals of the motor. The method further comprises: generating the voltage signals by utilizing the PWM signals for controlling the high-side transistors and the low-side transistor; determining the positions of the motor in accordance with the sensing signals.

### BRIEF DESCRIPTION OF THE DRAWINGS

The accompanying drawings are included to provide a further understanding of the invention, and are incorporated in and constitute a part of this specification. The drawings illustrate exemplary embodiments of the invention and, together with the description, serve to explain the principles of the invention.

FIG. 1 and FIG. 2 show schematic views illustrating a PM motor.

FIG. 3 shows a circuit diagram illustrating a motor control apparatus according to one embodiment of the present invention.

FIG. 4 shows the waveforms of 3-phase motor voltage signals V_{A}, V_{B} and V_{C} according to one embodiment of the present invention.

FIG. 5 shows a schematic view illustrating an equivalent model of the PM motor according to one embodiment of the present invention.

FIG. 6 shows a circuit diagram illustrating the control circuit according to one embodiment of the present invention.

FIG. 7 shows an equivalent circuit of the motor control apparatus for detecting the back-EMF of the motor according to one embodiment of the present invention.

FIG. 8 shows the waveform of the back-EMF, such as EMF_A, EMF_B and EMF_C, according to one embodiment of the present invention.

FIG. 9 shows the waveform of the back-EMF (EMF_A, EMF_B, EMF_C) and the output signals OA, OB, OC according to one embodiment of the present invention.

FIG. 10 shows a flowchart illustrating a method for detecting positions of a motor according to one embodiment of the present invention.

### DETAILED DESCRIPTION OF EMBODIMENTS

PM motors offer the advantages of high efficiency, small size, fast dynamic response, low noise and high reliability, etc. The field oriented control (FOC) and DQ control are utilized to drive the PM motors in general.

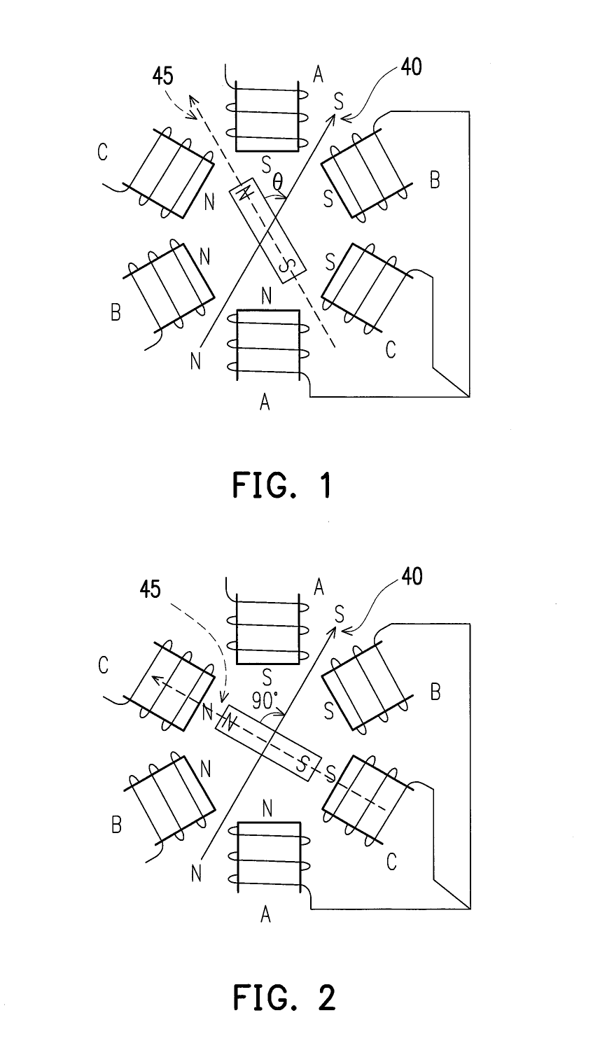

FIG. 1 and FIG. 2 show schematic views illustrating a PM motor. Referring to FIG. 1, a phase angle θ is existed between the stator flux 40 and the rotor flux 45. To achieve the high efficiency sensor-less motor control, when PM motor speed is higher than a specific value, the field oriented control (FOC) regulates the phase angle θ approximately equal to 90° (the stator field and the rotor field are orthogonal that shown in FIG. 2).

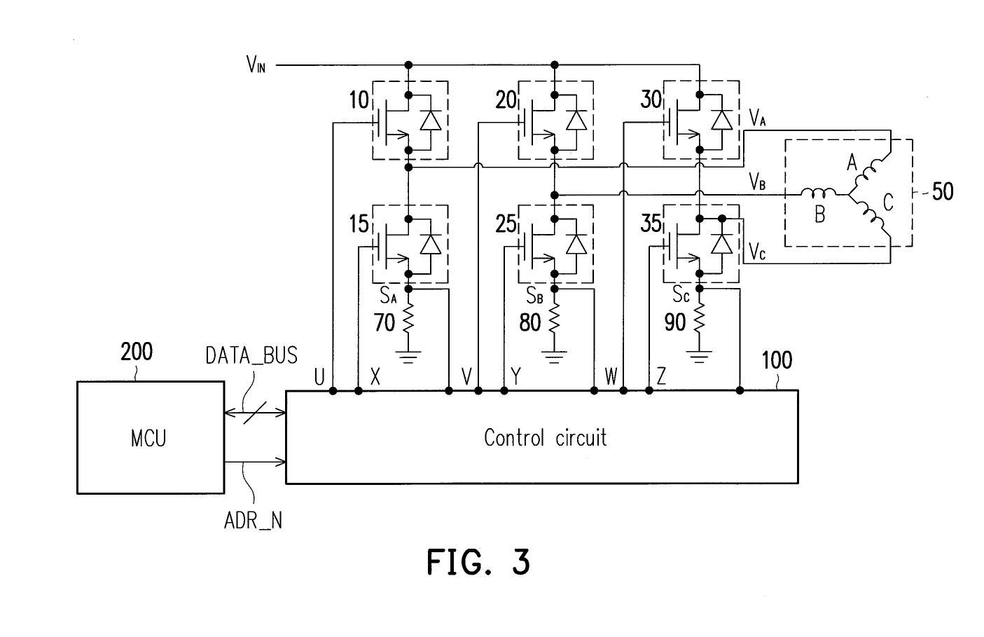

FIG. 3 shows a circuit diagram illustrating a motor control apparatus according to one embodiment of the present invention. The motor control apparatus shown in FIG. 3 is configured for controlling a permanent magnet (PM) motor 50. The motor control apparatus comprises a control circuit 100, high-side transistors 10, 20, and 30 and low-side transistors 15, 25, and 35, resistors 70, 80, and 90 and microcontroller (MCU) 200. The permanent magnet (PM) motor 50 comprises stator-windings A, B and C. The transistors 10, 15, 20, 25, 30, and 35 develop a three-phase bridge driver configured to drive the stator's winding A, B, C respectively. The high-side transistors (for example, transistors 10, 20, and 30) are coupled to the input power source VIN. The low-side transistors (for example, transistors 15, 25, and 35) are coupled to the ground through current-sense resistors 70, 80, and 90. The current-sense resistors 70, 80, and 90 are configured to detect the motor currents and back electro-motive force (regarded as Back-EMF). A terminal of the resistor 70 and the stator-winding A are series coupled to each other through the transistor 15. Another terminal of the resistor 70 is connected to the ground. A terminal of the resistor 80 and the stator-winding B are series coupled to each other through the transistor 25. Another terminal of the resistor 80 is connected to the ground. A terminal of the resistor 90 and the stator-winding C are series coupled to each other through the transistor 35. Another terminal of the resistor 90 is connected to the ground. The resistors 70, 80, and 90 generate sensing signals S_{A}, S_{B}, S_{C} respectively in response to motor currents and back-EMF signals.

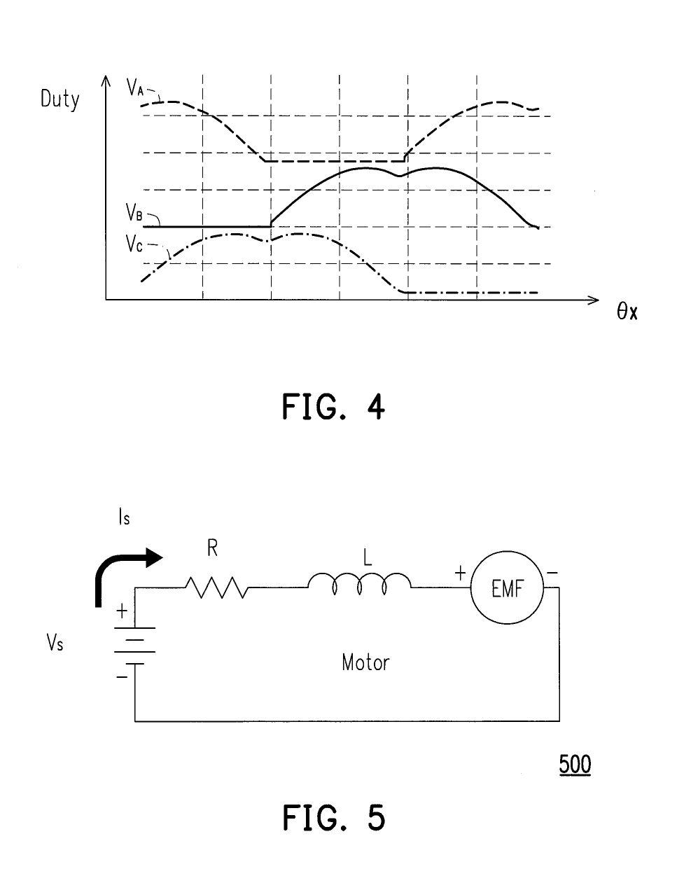

The control circuit 100 generates PWM (pulse width modulation) signals U, X, V, Y, W, and Z configured to drive/control transistors 10, 15, 20, 25, 30, and 35 respectively. The PWM signals U, X, V, Y, W, and Z are configured to control the high-side transistors 10, 20, and 30 and the low-side transistor 15, 25, and 35 for generating the sensing signals (for example, S_{A}, S_{B}, and S_{C})/voltage signals (for example, V_{A}, V_{B}, and V_{C}). The microcontroller (MCU) 200 is take control of the control circuit 100 through a data bus DATA_BUS and address signals ADR_N. The microcontroller 200 comprises a program memory, a data memory and an oscillator for running the program instructions. In accordance with the program instruments of the microcontroller 200, the control circuit 100 will generate the PWM signals U, X, V, Y, W, and Z to produce 3-phase motor voltage signals V_{A}, V_{B}, and V_{C} for diving the motor 50. The PWM signals U, X, V, Y, W, and Z are generated in accordance with elements Duty and θx shown in FIG. 4.

FIG. 4 shows the waveforms of 3-phase motor voltage signals V_{A}, V_{B} and V_{C} according to one embodiment of the present invention. The amplitudes of 3-phase motor voltage signals V_{A}, V_{B}, and V_{C} are programmed by the element Duty. The angle of 3-phase motor voltage signals V_{A}, V_{B}, and V_{C} is determined by the element θx.

FIG. 5 shows a schematic view illustrating an equivalent model 500 of the PM motor according to one embodiment of the present invention. The equivalent model 500 of the PM motor comprises a motor voltage signal source for generating a motor voltage signal V_{S}, a winding resistance R, a winding inductance L and an electromotive force source EMF (e.g., back-EMF). The motor voltage signal V_{S} that is applied to drive the PM motor. The relationships among a motor phase current I_{S}, the winding inductance L, the winding resistance R, the motor voltage signal V_{S}, and the EMF can be expressed as an equation (1).

$$\frac{d ( {I}_{s} )}{d t} = - \frac{R}{L} \times {I}_{s} + \frac{1}{L} \times ( {V}_{S} - EMF ) \qquad ( 1 )$$

where I_{S} is the motor phase current; EMF is the Back-EMF of the PM motor.

Once the voltage V_{S} (which creates an electro-motive force) is applied to a motor's armature, the motor's armature begins to rotate, and an amount of electrical resistance is generated by the rotating magnetic field correspondingly. This kick-back force is referred to “Back Electro-motive Force” or the Back-EMF. The faster the motor's armature turns, the more the Back-EMF is produced. The definition of the speed for the motor's armature is described by “volts per thousand RPM” or “Volts/(rad/sec)”.

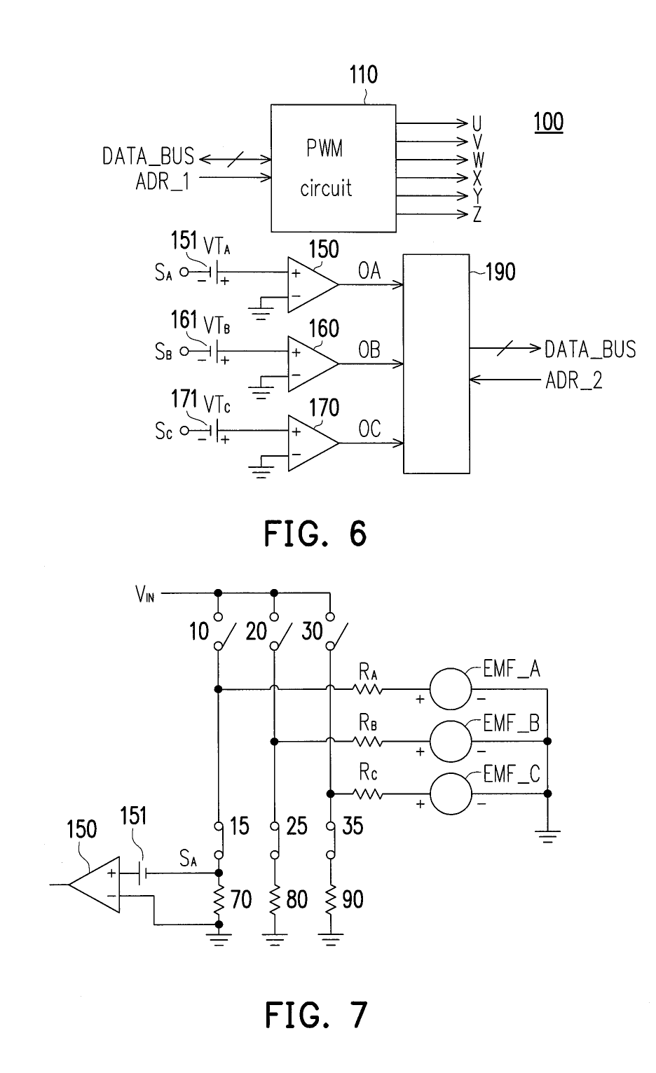

FIG. 6 shows a circuit diagram illustrating the control circuit 100 according to one embodiment of the present invention. The control circuit 100 includes a pulse-width-modulation (PWM) circuit 100, comparators 150, 160, and 170, bias voltage source 151, 161 and 171, and a tri-state buffer 190. The PWM circuit 110 receives the commands (instructions) from the data bus DATA_BUS and the address signal ADR_1 for generating PWM signals U, X, V, Y, W, Z. The comparator 150 is configured to receive the signal S_{A} through a threshold VT_{B} (the cross voltage of the bias voltage source 151) for generating an output signal OA. If the level of the signal S_{A} is lower than the threshold VT_{A}, the output signal OA will be at logic-low. The comparator 160 is configured to receive the signal S_{B} through a threshold VT_{B} (the cross voltage of the bias voltage source 161) for generating an output signal OB. If the level of the signal S_{B} is lower than the threshold VT_{A}, the output signal OB will be at logic-low. The comparator 170 is configured to receive the signal S_{C} through a threshold VT_{C} (the cross voltage of the bias voltage source 171) for generating an output signal OC. If the level of the signal S_{C} is lower than the threshold VT_{C}, the output signal OC will be at logic-low. The output signals OA, OB, and OC are coupled to the data bus DATA_BUS through the tri-state buffer 190. The tri-state buffer 190 is triggered by the address signals ADR_2.

FIG. 7 shows an equivalent circuit of the motor control apparatus for detecting the back-EMF of the motor 50 according to one embodiment of the present invention. Referring to FIG. 7, when the control circuit 100 in FIG. 1 associated with the three-phase bridge driver (transistors 10, 15, 20, 25, 30, and 35) generates the motor voltage signals V_{A}, V_{B}, V_{C} configured to drive the motor 50, the motor 50 will produce back-EMF, such as EMF_A, EMF_B, EMF_C (shown in FIG. 7). Once the back-EMF is generated, the transistors 10, 20, and 30 (high-side transistors) will be turned off, and the transistors 15, 25, and 35 (low-side transistors) will be turned on for detecting the back-EMF. For example, the level of the sensing signal S_{A} in resistor 70 can be expressed as an equation (2).

$${V}_{SA} = \frac{{R}_{70}}{{R}_{A} + {R}_{70}} \times ( EMF\_A ) \qquad ( 2 )$$

where V_{SA} is a voltage of the signal S_{A}; R₇₀ is the resistance of the resistor 70; R_{A}, R_{B} and R_{C} are the resistances of winding A through winding C of the motor 50.

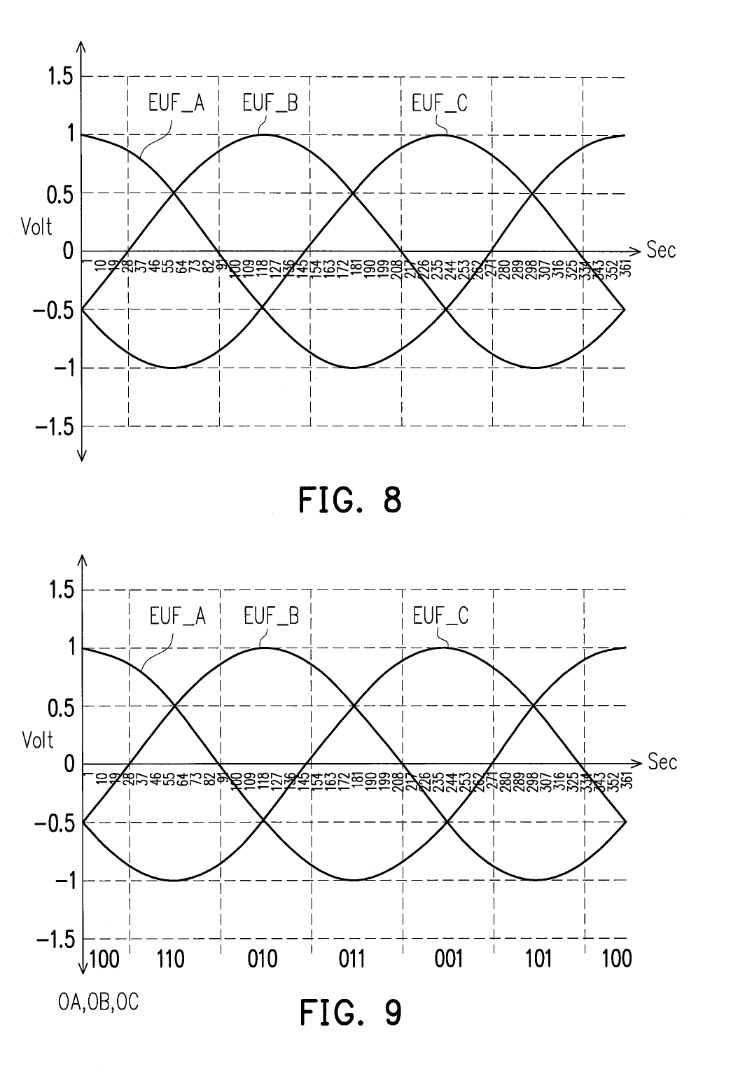

FIG. 8 shows the waveform of the back-EMF, such as EMF_A, EMF_B and EMF_C, according to one embodiment of the present invention. Referring to FIG. 8, the EMF_A, EMF_B and EMF_C can be obtained with reference to the equation (2). The X-axis of the FIG. 8 has units of Volts, and the Y-axis of the FIG. 8 has units of seconds.

FIG. 9 shows the waveform of the back-EMF (EMF_A, EMF_B, EMF_C) and the output signals OA, OB, OC according to one embodiment of the present invention. The motor position can be detected by the back-EMF (EMF_A, EMF_B, EMF_C) of the motor. The back-EMF of the motor can be detected with current-sense resistors 70, 80, and 90 and the sensing signals S_{A}, S_{B}, and S_{C}. According to the status of the output signals OA, OB, and OC, the microcontroller 200 can get the motor position information to startup the motor without jerk.

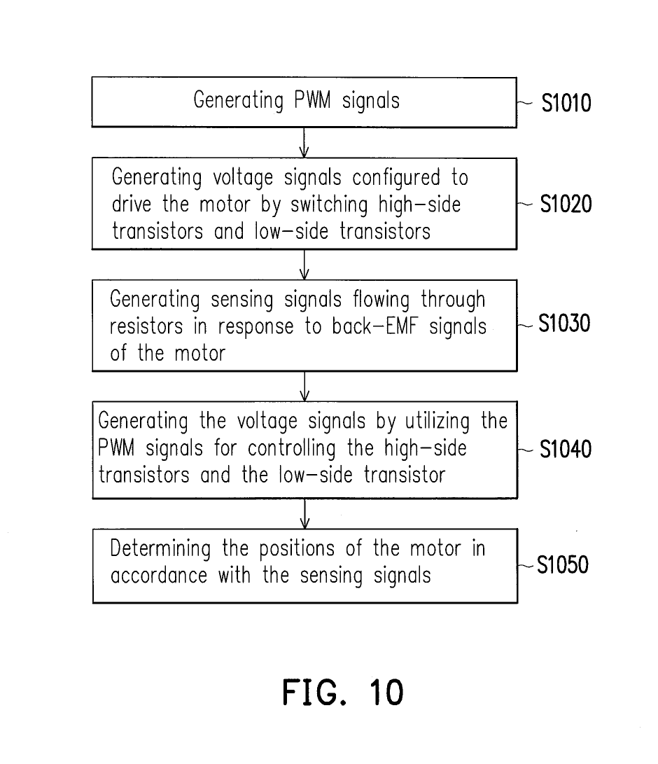

FIG. 10 shows a flowchart illustrating a method for detecting positions of a motor according to one embodiment of the present invention. In the present embodiment, the method for detecting positions of the motor is applicable to the motor control apparatus of FIG. 3. Each step of the method for detecting positions of the motor is described herein. Referring to FIG. 3 and FIG. 10, in step S1010, the control circuit 100 generates PWM signals, wherein the microcontroller 200 is configured to take control of the control circuit 100. In step S1020, the high-side transistors (for example, transistors 10, 20, and 30) and the low-side transistors (for example, transistors 15, 25, and 35) generate the voltage signals (for example, V_{A}, V_{B}, and V_{C}) by utilizing the PWM signals configured to drive the motor 50. In step S1030, the resistors (for example, the resistors 70, 80, and 90) coupled to the low-side transistors 15, 25, and 35 generate sensing signals (for example, S_{A}, S_{B}, and S_{C}) flowing through resistors 70, 80, and 90 in response to back-EMF signals of the motor 50. In step S1040, the control circuit 100 controls the high-side transistors and the low-side transistors for generating the voltage signals (for example, V_{A}, V_{B}, and V_{C}) by utilizing the PWM signals. Furthermore, in step S1050, the control circuit 100 determines the positions of the motor 50 in accordance with the sensing signals S_{A}, S_{B}, and S_{C}. The techniques combined with detailed actuation of electronic components are already described in the above embodiments of the present invention.

Although the present invention and the advantages thereof have been described in detail, it should be understood that various changes, substitutions, and alternations can be made therein without departing from the spirit and scope of the invention as defined by the appended claims. That is, the discussion included in this invention is intended to serve as a basic description. It should be understood that the specific discussion may not explicitly describe all embodiments possible; many alternatives are implicit. The generic nature of the invention may not fully explained and may not explicitly show that how each feature or element can actually be representative of a broader function or of a great variety of alternative or equivalent elements. Again, these are implicitly included in this disclosure. Neither the description nor the terminology is intended to limit the scope of the claims.

What is claimed is:

1. A circuit for detecting positions of a motor, comprising:
a control circuit generating PWM signals;
high-side transistors and low-side transistors generating voltage signals configured to drive the motor;
resistors coupled to the low-side transistors, for generating sensing signals in response to motor currents and back-EMF signals;
a microcontroller configured to take control of the control circuit;
wherein the PWM signals are configured to control the high-side transistors and the low-side transistors for generating the voltage signals; high-side transistors are coupled to an input power source; the low-side transistors are coupled to the ground via the resistors; the control circuit is configured to determine a motor position in accordance with the sensing signals.

2. The circuit as claimed in claim 1, in which the sensing signals are generated in response to the back-EMF signals of the motor for determining the motor position.

3. The circuit as claimed in claim 1, in which the sensing signals are generated by detecting the back-EMF signals of the motor when the high-side transistors are turned off and the low-side transistors are turned on.

4. The circuit as claimed in claim 1, in which the control circuit comprising:
comparators, configured to detect the sensing signals,
wherein the microcontroller is configured to receive the output signals of the comparators.

5. The circuit as claimed in claim 1, in which the microcontroller comprising a program memory, a data memory and an oscillator.

6. A method for detecting positions of a motor, comprising:
generating PWM signals;
generating voltage signals configured to drive the motor by switching high-side transistors and low-side transistors; and
generating sensing signals flowing through resistors in response to back-EMF signals of the motor;
generating the voltage signals by utilizing the PWM signals for controlling the high-side transistors and the low-side transistor; and
determining the positions of the motor in accordance with the sensing signals.

7. The method as claimed in claim 6, in which the resistors are coupled to the low-side transistors for detecting motor currents.

8. The method as claimed in claim 6, in which the PWM signal is generated by a control circuit; the control circuit is controlled by a microcontroller.

9. The method as claimed in claim 6, in which the sensing signals are generated by detecting the back-EMF signals of the motor when the high-side transistors are turned off and the low-side transistors are turned on.

10. The method as claimed in claim 8, in which the control circuit comprising:
comparators, configured to detect the sensing signals,
wherein the microcontroller is coupled to receive the output signals of the comparators.
